(19) United States
(12) Patent Application Publication
(10) Pub. No.: US 2007/0246308 A1
(43) Pub. Date: Oct. 25, 2007

(54) MOUNTAINBOARD

(75) Inventors: Andre SAUVE, Gatineau (CA); SEBASTIEN DALLAIRE, Montreal (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: 6144322 CANADA INC., Gatineau (CA)

(21) Appl. No.: 11/379,496

(22) Filed: Apr. 20, 2006

(51) Int. Cl. F16D 65/14

(52) U.S. Cl. 188/2 D

(57) ABSTRACT

A mountain board having a leg-actuated safety brake mechanism and a leg-actuated brake mechanism. The brake mechanism includes a displaceable pad or cup attached to the top region of a post attached to, and extending from, the mountain board. The safety brake mechanism includes a safety brake lever, or push rod, nested in the displaceable pad. The safety brake mechanism and the brake mechanism can be coupled to the same brake for seizing wheel rotors The safety brake mechanism is disengaged upon a rider pushing the push rod. The brake mechanism is functional only upon the safety brake having been disengaged. A steering mechanism including resilient members interconnecting the wheels to their respective yokes provides improved carving capabilities. Chamber-less tires with open cavities provide puncture-proof feature.

### FIELD OF THE INVENTION

The present invention relates generally to mountain boards. More particularly, the present invention relates to mountain boards having brake and safety brake mechanisms operable by a rider's leg.

### BACKGROUND OF THE INVENTION

The popularity of recreational devices, such as the mountain boards listed above, has seen a recent increase amongst sports enthusiasts. This increase is attributable at least in part to the popularity of snowboarding and of extreme sports in general. However, a mountain board that would be deemed an adequate off-season replacement for snowboards is yet to be seen and, potential riders who are not quite daring enough to practice extreme sports but who would like access to safer versions of such sports have limited alternatives.

Mountain boards with or without braking mechanisms are known in the art. They generally include a frame connecting wheel assemblies, the frame and the wheel assemblies cooperating to provide steering capabilities to the rider. Some of these mountain boards also include braking capabilities. For instance, Canadian Patent Application No. 2,418,259, to Attey, discloses a two-wheeled board having a leg actuated braking system and a pivotable front wheel for direction control. The braking system includes a standard bicycle caliper brake (V-brake), which engages the rim of the rear wheel, and a leg actuated braking member for actuating a caliper brake through a cable.

U.S. Patent Application Publication No. 2003/0122335, to Beck also discloses a two-wheeled board having a leg actuated braking system and a pivotable front wheel for direction control. This board is similar to the previously discussed Attey board with the main difference between this board and the Attey board being that the leg braking member directly engages the rear wheel instead of actuating a caliper brake.

Further mountain boards include that disclosed in U.S. Pat. No. 4,445,699, to Darasko, which teaches a two-wheeled board having a foot actuated braking system and a pivotable front wheel for direction control. The front wheel is supported by two sets of arms. One set of arms is fixed and includes curved longitudinal slots that the wheel axle slides within. The second set of arms is connected to the wheel axle and pivotally connected to a steering wheel mounted to the board. The foot brake is a simple lever that applies friction to a wheel when depressed. Another two-wheeled board with a braking system similar to that of Darasko is disclosed in U.S. Pat. No. 4,991,861, to Carn, which further discloses interconnected, pivotable front and rear wheels.

Yet another mountain board is disclosed in U.S. Pat. No. 6,398,237, to Attey, in which a mountain board having a spring-biased foot-actuated braking system and a pivotable front wheel for direction control is taught. When the rider's foot is removed from the foot brake, the brake is actuated, thereby providing a “dead man” safety brake. However, in order to stop in a non-abrupt manner, the rider must controllably release foot pressure on the brake. This can be quite challenging when trying to maintain balance and control of the mountain board in real-life situations.

Other prior art mountain boards include mountain boards with hand-actuated braking. Such a mountain board is disclosed in, for example, U.S. Pat. No. 6,568,695, to Dornan.

To attract snowboarders to an off season activity that would be as challenging as snowboarding, a mountain board allowing sharp turns, i.e. a mountain board with good carving capabilities, and having good speed control would be desirable. To have good carving capabilities, a mountain board should have pivotable front and rear wheel assemblies. The Carn patent above does teach pivotable front and rear wheels but the wheels are interconnected by rods, which are prone to retaining dirt and becoming damaged in a wild or semi-wild environment such as an off-season ski slope.

To attract more cautious riders, good speed control is particularly important since falling off a mountain board onto hard ground at high speed is quite risky and certainly more dangerous than falling off a snowboard. Thus, a safe braking mechanism would allow recreational sport practitioners to adopt mountain boarding as a recreational activity. Ideally, the braking mechanism of the mountain board would be such that the rider would be able to actuate the braking mechanism while maintaining a natural stance on the board. Further, the braking mechanism would be such that a safety brake automatically engages when the rider falls off or steps off the mountain board.

It is, therefore, desirable to provide a mountain board with a controllable braking mechanism having a safety brake, the braking mechanism allowing the rider to maintain a natural stance on the mountain board. It is also desirable to provide a mountain board that allows good carving capabilities. In addition to providing a challenging and relatively safe experience to riders, such a mountain board would provide business opportunities to ski resort operators in the off-season.

### SUMMARY OF THE INVENTION

It is an object of the present invention to obviate or mitigate at least one disadvantage of previous mountain boards.

In a first aspect, the present invention provides a mountain board having a brake for engaging a wheel of the mountain board in response to a braking force. The mountain board includes an upwardly extending post and a safety brake assembly. The upwardly extending post is fixedly attached to a mountain board frame, and has a bearing surface. The safety brake assembly includes a catch coupled to the brake, the catch pivotally attached to the post and biased for engaging the brake; and a push rod nested in the bearing surface for receiving a safety brake release force. The push rod engages the catch for releasing the brake in response to the safety brake release force.

According to embodiments of the present aspect, the safety brake assembly further includes a catch spring means for biasing the catch to engage the brake. The safety brake mechanism can further include a push rod spring means for biasing the push rod away from the bearing surface. The push rod spring means can include a coil spring having a first end attached to the push rod and a second end attached to the post.

In yet another embodiment, the safety brake mechanism can further include a coupling means for coupling the brake to the catch. The coupling means can have a cable and a bracket, where the bracket is pivotally attached to the post. A first end of the cable is attached to the bracket, a second end of the cable is coupled to the brake, and the bracket is biased by the catch. The mountain board can further include a brake mechanism, the brake mechanism including a brake actuation means disposed at the bearing surface and a cable means having a first end coupled to the brake actuation means and a second end coupled to the bracket. The brake actuation means can engage the brake in response to the braking force when the push rod engages the catch for releasing the brake. The cable means can include a cable having a sheath. The brake actuation means can include a cable holding means formed on the bearing surface, where a first end of the cable is attached to the cable holding means and a second end of the cable is coupled to the bracket. The brake actuation means includes a cup displaceable with respect to the bearing surface. The cup has a first sheath stop receiving a first end of the sheath, where a second end of the sheath is disposed in a second sheath stop formed on the post, such that displacement of the cup towards the bearing surface displaces the sheath for pulling the cable. The push rod is nested in the cup.

In another embodiment of the present aspect, the mountain board further includes a yoke for holding a wheel, the yoke being pivotally connected to the mountain board frame, and, a shock absorber connected between the mountain board frame and the yoke. The yoke can include an extending member, a linkage and a wheel attachment. The linkage is pivotally attached to the extending member and pivotally attached to the wheel attachment. The yoke can further include a flexible member having a first end attached to extending member and a second end coupled to the linkage, and the brake includes a caliper which can be attached to the wheel attachment for seizing a rotor of the wheel.

In a further embodiment, the wheel of the mountain board includes a chamber-less tire. The chamber-less tire can include a plurality of open cavities.

In a second aspect, the present invention provides a two wheeled board. The board can include a safety brake assembly, a brake actuating means and a wheel brake. The safety brake assembly provides a first braking force, the first braking force being negated in response to a load. The brake actuating means provides a second braking force when the first braking force is negated. The wheel brake is operatively connected to the safety brake assembly and the brake actuating means. The wheel brake seizing one wheel of the mountain board in response to one of the first braking force and the second braking force.

In yet further embodiments of the present aspect, the post includes a channel along which the push rod can be displaced, the brake includes a caliper, and the push rod includes a slot, where the slot is sized for receiving the catch.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A is a side view of a mountain board embodiment of the present invention;

FIG. 1B is a top view the mountain board embodiment of FIG. 1A;

FIG. 2 is a side view of the extending member of FIG. 1A showing elements of the safety brake mechanism and of the brake mechanism;

FIG. 3 is a cross-sectional view of the extending member of FIG. 1A showing elements of the safety brake mechanism and of the brake mechanism;

FIG. 4 is an exploded view of the extending member of FIG. 1A showing elements of the safety brake mechanism and of the brake mechanism;

FIG. 5A is a front view of the front wheel yoke of the embodiment of FIG. 1A;

FIG. 5B is a side view of the front wheel yoke of the embodiment of FIG. 1A; and

FIG. 6 is a perspective view of a tire of the mountain board embodiment of FIG. 1A.

### DETAILED DESCRIPTION

For the purpose of this application, the term mountain board includes any type of wheeled board mountable by a rider. Generally, the present invention provides a mountain board having brake and safety brake mechanisms actuated by a rider's leg. The brake and safety brake mechanisms are selectively coupled to a braking means for effecting braking of a wheel of the mountain board. The brake mechanism is operable only when the safety brake mechanism is disengaged i.e., a disengagement of the safety brake mechanism renders the brake mechanism operable. Mountain boards of the present invention also provide a steering mechanism allowing good carving capabilities.

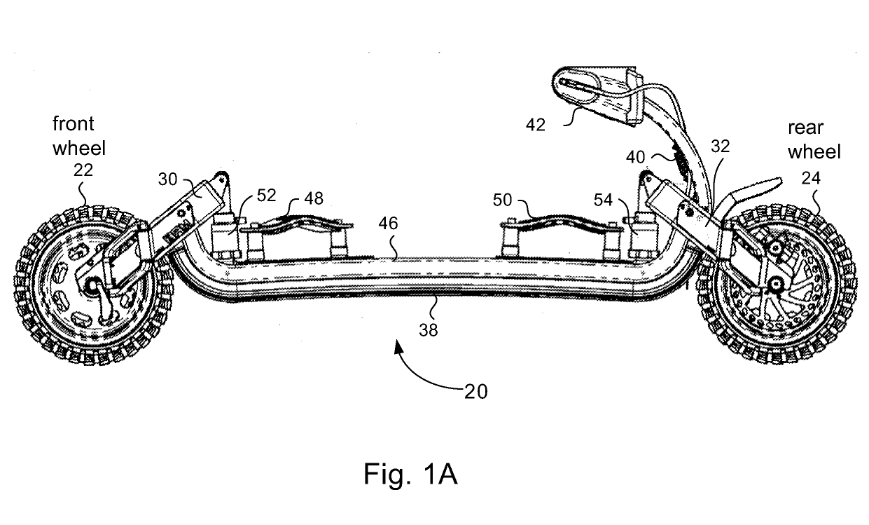

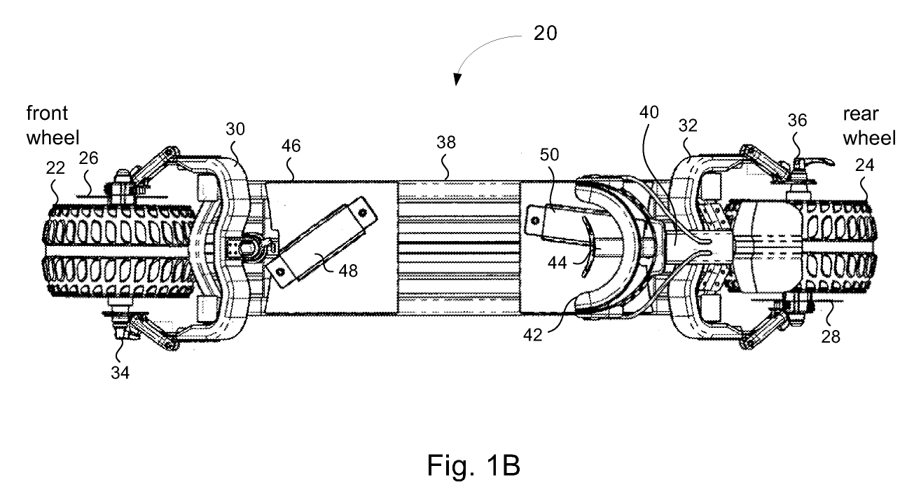

FIG. 1A shows a side view of an embodiment of a mountain board 20 of the present invention while FIG. 1B shows a top view of the mountain board 20 of FIG. 1A. With respect to the FIGS. 1A and 1B, the mountain board 20 includes wheels 22 and 24 equipped with brake rotors 26 and 28. The front wheel 22 is mounted in a front yoke 30 while the rear wheel is mounted in a rear yoke 32. The wheels 22 and 24 are be held respectively in the front and rear yokes 30 and 32 via quick release mechanisms 34 and 36 as will be understood by a worker skilled in the art.

The mountain board 20 includes a frame 38 to which are attached the front and rear yokes 30 and 32 via shock absorbers 52 and 54 respectively for softening the ride. Additionally, as will be described later, the front and rear yokes 30 and 32 can be pivotally attached to the frame. A post 40 is fixedly attached to the frame 38 via fastening means (not shown) and includes a leg rest 42 for actuating a brake mechanism. The leg rest 42 can also be referred to as a bearing surface. The post 40, which extends from the frame 38, includes a safety brake mechanism, which can include a safety brake lever 44 nested in the leg rest 42. The safety brake lever can also be referred to as a push rod, which receives a safety brake release force provided by the rider. The brake and safety brake mechanisms are described further below.

Additionally, the mountain board 20 includes a platform 46 fixed to the frame 38. A rider mounting the mountain board 20 steps on the platform 46 and positions his/her feet in the foot harnesses 48 and 50, which can be adjustable.

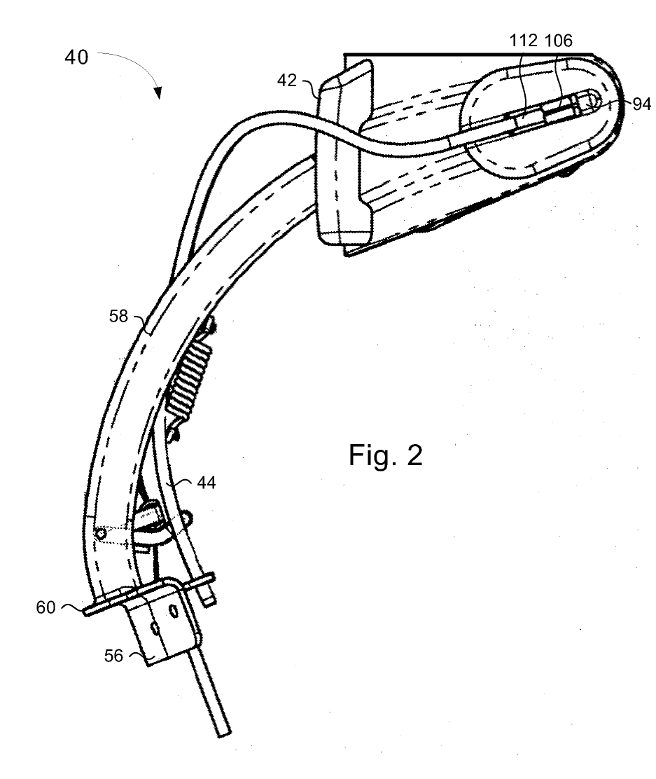

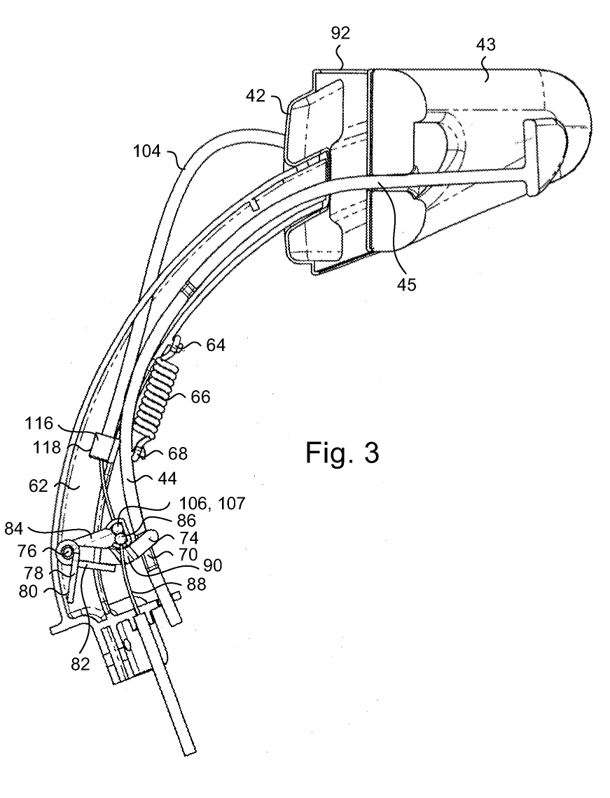

Details on the post 40, on the braking mechanism and on the safety brake are described in relation to FIGS. 2 and 3.

In FIG. 2, the post 40 is shown separate from the mountain board 20. The post 40 includes an attachable end 56 for attaching to the frame 38. The post 40 is shown detached, however those skilled in the art will understand that post 40 can be permanently connected to frame 38. A member 58, of arbitrary shape, extending between the abutment 60 and the leg rest 42 includes a passageway 62, shown in FIG. 3, through which the safety brake lever 44 can slide. The leg rest 42 can be welded, bolted or attached to the top end of the member 58 via any other appropriate means. As shown in FIG. 3, the leg rest 42 includes a displaceable pad 43 defining a slot 45 through which the safety brake lever 44 can also slide. The displaceable pad 43, also referred to as a cup, is used for braking, as will now be described.

An embodiment of the safety brake mechanism is as follows. The safety brake lever 44 can include an opening, such as a slot 70, which is for inter-fitting and for cooperating with a catch 74 pivotally attached to an axis 76 of the post 40. The catch 74 is biased by a spring means such as a spiral spring 78, which can be disposed about the axis 76. The spiral spring 78 has a first end 80 for abutting against the inside of the post 40 and a second end 82 for applying a biasing force to the catch 74. The post 40 also includes a notch 64 to which a spring means such as a coil spring 66 can be attached at a first end while the second end of the coil spring 66 can be attached to a notch 68 formed on the safety brake lever 44. The coil spring 66 thus biases upwardly the safety brake lever 44.

In the depiction of FIG. 3, where, as in FIG. 2, the safety brake mechanism is in an actuated position, the catch 74 is biased in an upward position by the spiral spring 78. As such, the catch 74 pushes a cable bracket 84 upward. The cable bracket 84 is also pivotally attached to the axis 76 of the post 40 and includes a slotted wall (not shown) for receiving a terminating end 86 of a brake cable 88, which can be coupled to a braking means such as, for example, a caliper (not shown) for seizing the rotor 28 (rear wheel 24) or, the rotor 28 (rear wheel 24) and the rotor 26 (front wheel 22). In this exemplary embodiment, the cable 88 passes through an opening 90 defined by the catch 74.

As would be understood by a skilled worker, the caliper system, or a braking system in general, includes a biasing means for biasing a caliper in an open position. As such, the spiral spring 78 must be able to apply a force greater than the resultant biasing force provided by all the calipers in the braking system, the calipers of the braking system all being connected to the cable 88, in order to be able to actuate safety braking.

The safety brake is disengaged as follows. A rider mounts the mountain board 20 and places one of his legs in the leg rest 42. When ready to ride, the rider applies a force with his leg on the safety brake lever 44. This force can be called the safety brake release force. When the force applied by the rider' leg is sufficient to overcome, or negate, the counterforces applied by the catch 74, the safety brake lever slides downward, inside the passageway 62. As the safety brake lever 44 slides in the passageway 62, the catch 74 is pushed downward and the slot 70 and the catch 74 are separated. At this point, further inward displacement of the safety brake lever 44 has no effect on the catch 74. As will be understood by a skilled worker, each caliper effecting braking of a wheel when the safety brake lever 44 is in an upward position is effectively opened upon the safety brake lever 44 being pushed in (i.e. downwardly). As will be clear to those of skill in the art, the safety brake system can be adjusted to engage only at the point where the catch 74 and the slot 70 begin to overlap, i.e. when the rider almost completely ceases to apply force to the safety brake lever. Such a situation means that a rider can maintain a natural stance on the mountain board without worrying about stopping abruptly because the safety brake lever 44 is not completely depressed.

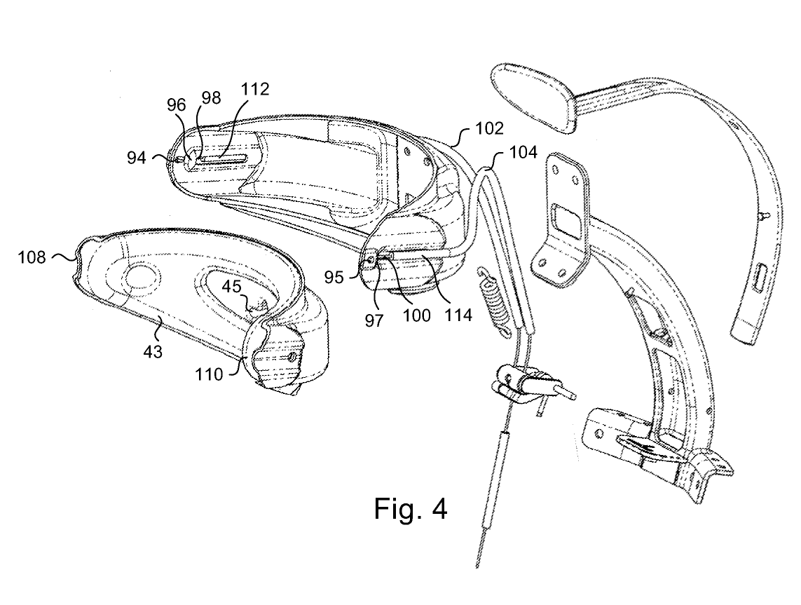

While the present invention includes embodiments with only a safety brake mechanism such as described above, it also includes embodiments additionally including a brake mechanism as described here in relation to FIGS. 3 and 4.

The displaceable pad 43 can be inter-fitted with a fixed part 92 of the leg rest 42. The fixed part 92 can include retaining means, such slotted walls 94 and 95, for receiving and retaining terminating ends 96 and 97 of brake cables 98 and 100, the brake cables 98 and 100 being partially covered by sheaths 102 and 104 respectively. The brake cables 98 and 100 also include terminating ends 106 and 107, which can be disposed in a retaining means such as a slotted wall of the cable bracket 84, the cable bracket shown in FIG. 3 as fixed with respect to the member 58. As stated previously, the displaceable pad 43 can define a slot 45 for allowing passage of the safety brake lever 44. The displaceable pad 43 can further include sheath stops (not shown) in ends 108 and 110 of the displaceable pad 43 for receiving the first ends 112 and 114 of the sheaths 102 and 104. The other ends of the sheaths 102 and 104 are disposed in fixed sheath stops 116 and 118 shown in FIG. 3.

As mentioned above, when the safety brake lever 44 is depressed or pushed inwardly in relation to the displaceable pad 43, the safety brake mechanism is disengaged and the caliper effecting braking disengage from each wheel rotor. Upon disengagement of the safety brake mechanism, the braking mechanism, including the displaceable pad 43, the cables 98 and 100, the sheaths 102 and 104, the cable bracket 84, the cable 88 and the caliper and rotors, become functional.

A rider mounted on the mountain board 20 with the safety brake lever 44 fully pushed-in can actuate the braking mechanism by pushing on the displaceable pad 43 shown in FIG. 3. Pushing on the displaceable pad 43 pushes on the sheaths 102 and 104, which can be bendable and of substantially constant length, i.e. substantially non-compressible. Pushing on the sheaths 102 and 104 causes the sheaths 102 and 104 to pull the cables 98 and 100 upwards thereby pulling on the cable bracket 84, which in turn pulls on the cable 88. Pulling the cable 88, which is coupled to the caliper means, engages the caliper means thereby effecting braking.

As would be understood by a worker skilled in the art, caliper means can be attached to each wheel of the mountain board and each caliper means can have its braking power adjusted with respect to the other caliper means. For example, in a two wheel mountain board, the caliper of the rear wheel can be adjusted to a higher braking power than the caliper means of the front wheel to prevent the chance of the mountain board 20 flipping over during braking. As will be described later, the present invention allows for the safety brake mechanism and a regular brake to use the same caliper or calipers.

The feature of having a safety brake and a regular brake using the same calipers can be embodied, for example, in the following combinations. A leg actuated safety brake and a leg actuated regular brake; a leg actuated safety brake and a hand actuated regular brake; a foot actuated safety brake and a leg actuated regular brake; and a foot actuated safety brake and a hand actuated regular brake.

Although the post 40 containing a braking mechanism was shown as being disposed near the rear wheel 24 of the mountain board 20, a worker of ordinary skill in the art would understand that the it can be disposed near the front wheel 22. Additionally, a worker in the art would understand that the mountain board 20 can be operated in reverse, i.e. with the rear wheel 24 leading the descent. The mountain board 20 can also be equipped with two posts similar to the post 40 containing a braking mechanism. This would provide a rider with the option of braking with his rear leg and/or his front leg.

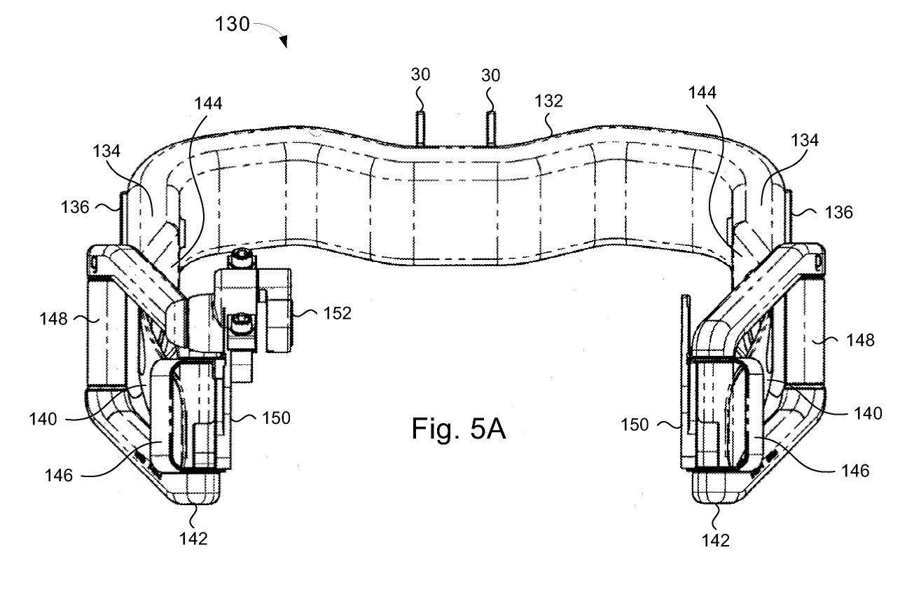

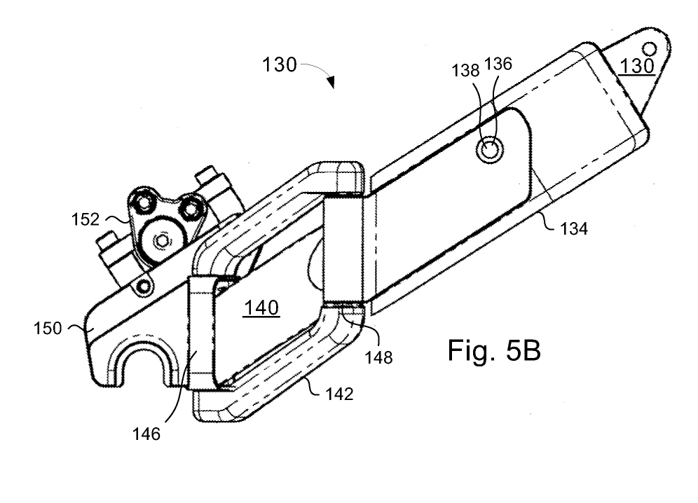

The steering mechanism will now be described in relation to FIGS. 1A, 1B, 5A and 5B. FIG. 5A depicts an embodiment of the front yoke 30, shown attached to the mountain board 20 in FIGS. 1A and 1B. The rear yoke 32 can be the same as the front yoke 30.

The front yoke 30 includes bored flanges 130 for pivotally attaching the yoke 30 to the shock absorber 52 through any suitable means. The bored flanges 130 are attached to transversal member 132 by welding or by any other appropriate means. The transversal member 132 is connected to two extending members 134, each defining a bore 136 for pivotally attaching, through any suitable means, the front yoke 30 to the frame 38 about an axis 138. The extending members 134 are slanted downwards as shown in FIG. 5B. The front yoke 30, pivotally attached to the frame 38 at the axis 138, and to the shock absorber 52 at the flanges 130, allows for stable operation of the mountain board 20 upon the mountain board 20 going over obstacles.

The front yoke 30 further includes flexible members 140 and linkages 142. As shown in FIG. 5B, the flexible members 140 and the linkages 142 are slanted downwards, as are the extending members 134. The flexible members 140 can be adjustably secured at one end to the extending members 134 via any suitable attachment means in areas 144. The flexible members 140 can be coupled to the linkages 142 by inserting the other end of the flexible member into retaining loops 146 secured to the linkages 142 by any suitable means. The other end of the flexible member 140 can be generally coupled to the wheel attachment 150. The linkages are pivotally attached to the extending members 134 in sleeves 148. A braking means such as, for example, a caliper 152, shown in FIG. 5A can be part of a wheel attachment such as wheel attachments 150, which are pivotally secured to the linkages 142. The caliper 152 is for seizing the rotor 26, shown in FIG. 1B, of the front wheel, thereby effecting braking of the front wheel. The flexible members 140 can be made of any suitable resilient material such as composite materials or resilient plastics.

The rear yoke 32, the shock absorber 54, the wheel 24, caliper means, wheel attachments, linkages and members of the rear yoke 32 are substantially functionally the same as their front wheel area counterparts and perform substantially the same tasks to yield substantially the same results.

A rider leaning towards one side of the mountain board 120 causes an inward flexing of the flexible members 140 (for both the front and rear wheels 22 and 24) disposed on the side being leaned towards. This inward flexing of the flexible members causes an inward turn of the front wheel 22 and an outward turn of the rear wheel 24 and, consequently, causes the mountain board 20 to turn towards the side being leaned towards by the rider. This steering mechanism is robust in that it does not have parts prone to catching debris on the ground and provides enhanced carving capabilities. Furthermore, as both the flexible members 140 are preferably resilient and matched in physical characteristics, they generally auto-centre the wheels once the rider centers his/her weight along the longitudinal axis of the mountain board 120.

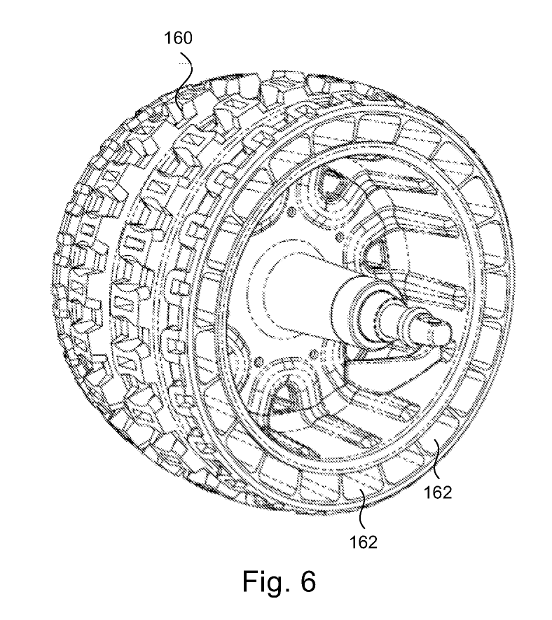

The front and/or rear wheels 22 and 24 can each include a tire 160 as shown in FIG. 6. The tire 160 can be a chamber-less tire including a plurality of open cavities 162. This provides for a puncture-proof lightweight tire.

The present invention described above through exemplary embodiments, provides a mountain board having brake and safety brake mechanisms operable by a rider's leg. The brake and safety brake mechanisms are selectively coupled to a braking means for effecting braking of a wheel of the mountain board. The brake mechanism is operable only when the safety brake mechanism is disengaged i.e., a disengagement of the safety brake mechanism renders the brake mechanism operable. The mountains boards of the present invention further include a steering mechanism comprising flexible members allowing for good carving capabilities.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A mountain board having a brake for engaging a wheel of the mountain board in response to a braking force, the mountain board comprising:
an upwardly extending post fixedly attached to a mountain board frame, the post having a bearing surface; and
a safety brake assembly including:
a catch coupled to the brake, the catch pivotally attached to the post and biased for engaging the brake; and
a push rod nested in the bearing surface for receiving a safety brake release force, the push rod engaging the catch for releasing the brake in response to the safety brake release force.

2. The mountain board of claim 1 wherein, the safety brake assembly further includes a catch spring means for biasing the catch to engage the brake.

3. The mountain board of claim 1 wherein, the safety brake assembly further includes a push rod spring means for biasing the push rod away from the bearing surface.

4. The mountain board of claim 2 wherein, the safety brake assembly further includes a coupling means for coupling the brake to the catch, the coupling means having:
a cable and a bracket, the bracket pivotally attached to the post, a first end of the cable being attached to the bracket, a second end of the cable coupled to the brake, the bracket being biased by the catch.

5. The mountain board of claim 1 wherein, the post includes a channel along which the push rod can be displaced.

6. The mountain board of claim 1 wherein, the brake includes a caliper.

7. The mountain board of claim 1 wherein, the push rod includes a slot, the slot being sized for receiving the catch.

8. The mountain board of claim 3 wherein, the push rod spring means includes a coil spring having a first end attached to the push rod and a second end attached to the post.

9. The mountain board of claim 4 further comprising:
a brake mechanism including:
a brake actuation means disposed at the bearing surface; and
a cable means having a first end coupled to the brake actuation means and a second end coupled to the bracket, the brake actuation means engaging the brake in response to the braking force when the push rod engages the catch for releasing the brake.

10. The mountain board of claim 9 wherein the cable means includes a cable having a sheath.

11. The mountain board of claim 10 wherein the brake actuation means includes
a cable holding means formed on the bearing surface, a first end of the cable being attached to the cable holding means and a second end of the cable being coupled to the bracket; and
a cup displaceable with respect to the bearing surface, the cup having a first sheath stop receiving a first end of the sheath, a second end of the sheath being disposed in a second sheath stop formed on the post, wherein displacement of the cup towards the bearing surface displaces the sheath for pulling the cable.

12. The mountain board of claim 11 wherein, the push rod is nested in the cup.

13. The mountain board of claim 1 further comprising:
a yoke for holding a wheel, the yoke being pivotally connected to the mountain board frame; and,
a shock absorber connected between the mountain board frame and the yoke.

14. The mountain board of claim 13 wherein, the yoke includes
an extending member,
a linkage and
a wheel attachment, the linkage being pivotally attached to the extending member and pivotally attached to the wheel attachment.

15. The mountain board of claim 14 wherein, the yoke further includes a flexible member having a first end attached to extending member and a second end coupled to the linkage.

16. The mountain board of claim 15 wherein, the brake is attached to the wheel attachment for seizing a rotor of the wheel.

17. The mountain board of claim 15 wherein, the brake includes a caliper.

18. The mountain board of claim 1 wherein, the wheel of the mountain board includes a chamber-less tire.

19. The mountain board of claim 18 wherein, the chamber-less tire includes a plurality of open cavities.

20. A two-wheeled mountain board comprising:
a safety brake assembly for providing a first braking force, the first braking force being negated in response to a load;
a brake actuating means for providing a second braking force when the first braking force is negated; and
a wheel brake operatively connected to the safety brake assembly and the brake actuating means, the wheel brake seizing one wheel of the mountain board in response to one of the first braking force and the second braking force.
